(19) United States
(12) Patent Application Publication
(10) Pub. No.: US 2021/0133759 A1
(43) Pub. Date: May 6, 2021

(54) METHOD, SYSTEM, AND NON-TRANSITORY COMPUTER-READABLE RECORD MEDIUM FOR PRIOR AUTHORIZATION OF TRANSACTION IN SHARED ACCOUNT

(71) Applicant: LINE Corporation, Tokyo (JP)

(72) Inventors: Heonjae JUNG, Seongnam-si (KR); Sooyoung KIM, Seongnam-si (KR)

(73) Assignee: LINE Corporation, Tokyo (JP)

(21) Appl. No.: 17/085,733

(22) Filed: Oct. 30, 2020

(30) Foreign Application Priority Data
Nov. 1, 2019 (KR) 10-2019-0138301

(51) Int. Cl. G06Q 20/42; G06Q 40/02; G06Q 20/40

(52) U.S. Cl. CPC G06Q 20/42; G06Q 20/405; G06Q 40/02

(57) ABSTRACT

Disclosed is a non-transitory computer-readable record medium, method, and apparatus for prior authorization of a transaction in a shared account. A shared account transaction method may include creating a shared account of which usage details are to be shared between the user and at least one member selected by the user from a friend list of a messenger installed on the computer apparatus in response to a shared account creation request from a user of the computer apparatus, transmitting a prior authorization message about the transaction request the at least one member through the messenger in response to a transaction request for the shared account, and executing a prior authorized transaction in the shared account based on a response of the at least one member to the prior authorization message.

### CROSS-REFERENCE TO RELATED APPLICATION(S)

This U.S. non-provisional application and claims the benefit of priority under 35 U.S.C. § 119 to Korean Patent Application No. 10-2019-0138301, filed Nov. 1, 2019, the entire contents of which are incorporated herein by reference in their entirety.

### BACKGROUND

### Technical Field

One or more example embodiments relate to technology for processing authorization of a transaction in a shared account.

### Related Art

Internet banking refers to a service that processes various financial transactions, such as deposits and withdrawals provided from a bank, using the Internet, and uses a variety of financial information and functions. To this end, a user may open an account in a bank and may use Internet banking through the account.

To use Internet banking, users install an agent, such as an application, on user terminals and process banking tasks through interaction with a server configured to manage such banking tasks using the corresponding agent.

Accordingly, a user may handle various banking tasks using an agent without a need to visit a bank directly.

### SUMMARY

According to some example embodiments, it is possible to process a transaction in a shared account through prior authorization from users using a messenger.

Also, according to some example embodiments, it is possible to mitigate or prevent the fraudulent use of a user having the transaction authority for a shared account.

According to an aspect of at least one example embodiment, a shared account transaction method executed on a computer apparatus, which includes at least one processor configured to execute computer-readable instructions included in a memory, may include, by the at least one processor, creating a shared account of which usage details are to be shared between the user and at least one member selected by the user from a friend list of a messenger installed on the computer apparatus in response to a request from a user of the computer apparatus, transmitting a prior authorization message about the transaction request to the at least one member through the messenger in response to a transaction request for the shared account; and executing a prior authorized transaction in the shared account based on a response of the at least one member to the prior authorization message.

The transmitting may include transmitting the prior authorization message that includes at least one of a transaction purpose and a transaction amount selected or input for a transaction in the shared account.

The transmitting may include transmitting the prior authorization message that includes payment request information of an affiliate store in response to a payment request using the shared account.

The prior authorization message may be configured as an action message that includes a user interface (UI) for inputting an intent to accept or deny to the transaction request.

The transmitting may include transmitting the prior authorization message if the transaction request corresponds to a transaction condition set to the shared account.

The transaction condition may include at least one of a business type category, an amount, and a time associated with the transaction.

The executing may include allowing the prior authorized transaction if a response to the prior authorization message meets a valid authorization processing condition set to the shared account.

The valid authorization processing condition may include at least one of a number of members or a rate of members and a response time that are recognized as valid authorization.

The valid authorization processing condition may be differently set based on the transaction condition.

The executing may include allowing a transaction in the shared account if actual contents of the transaction of the shared account correspond to transaction contents for which prior authorization has been acquired from the at least one member.

The shared account transaction method may further include, by the at least one processor, monitoring transactions in the shared account and providing members of the shared account with a notification about a certain transaction corresponding to a fraudulent use condition.

The providing may further include, by the at least one processor, monitoring transactions for which prior authorization is not acquired among the transactions in the shared account and determining whether a fraudulent use is present in the shared account based on at least one of a transaction time and a transaction location.

The shared account transaction method may further include, by the at least one processor, transmitting another prior authorization message about a setting change to the at least one member in response to a change in a setting related to the shared account by the user.

The shared account transaction method may further include, by the at least one processor, in response to a deletion request to delete a select member from members of the shared account or an addition request to add a select to the members of the shared account from the user, transmitting a prior authorization message that includes information about the select member to the members of the shared account other than the user.

The shared account transaction method may further include, by the at least one processor, setting a certain member selected by the user from among members of the shared account as a temporary master agent having a transaction authority for the shared account.

The setting may include setting at least one of a transaction type, a business type category, a time, and an amount for which the transaction authority of the temporary master agent is valid.

The shared account transaction method may further include, by the at least one processor, transmitting a prior authorization message about settings of the temporary master agent to the members of the shared account other than the user.

The shared account transaction method may further include, by the at least one processor, executing a transaction linked to a deposit request without prior authorization, if a deposit is made from the at least one member in response to the deposit request to the shared account from the user and then the transaction request for the shared account occurs with respect to the transaction linked to the deposit request.

According to an aspect of at least one example embodiment, there is provided a non-transitory computer-readable record medium storing instructions that, when executed by the at least one processor, cause the at least one processor to perform the shared account transaction method.

According to an aspect of at least one example embodiment, a server may include at least one processor configured to execute computer-readable instructions included in a memory. The at least one processor may be configured to create a shared account of which usage details are to be shared between the user and at least one member in response to a shared account creation request from a user of an electronic device, transmit a prior authorization message about the transaction request for the shared account to at least one electronic device of the at least one member through a messenger installed on the electronic device of the user in response to a transaction request for the shared account, and execute a prior authorized transaction in the shared account based on a response of the at least one member to the prior authorization message.

Further areas of applicability will become apparent from the description provided herein. The description and specific examples in this summary are intended for purposes of illustration only and are not intended to limit the scope of the present disclosure.

### BRIEF DESCRIPTION OF DRAWINGS

FIG. 1 is a diagram illustrating an example of a network environment according to at least one example embodiment;

FIG. 2 is a diagram illustrating an example of an electronic device and a server according to at least one example embodiment;

FIG. 3 is a diagram illustrating an example of components includable in a processor of an electronic device according to at least one example embodiment;

FIG. 4 is a flowchart illustrating an example of a method performed by an electronic device server according to at least one example embodiment;

FIGS. 5 and 6 illustrate examples of a user interface screen for describing a process of creating a shared account according to at least one example embodiment;

FIGS. 7 to 10 illustrate examples of a user interface screen for describing a process of processing prior authorization of a transaction in a shared account according to at least one example embodiment; and

FIGS. 11 to 13 illustrate examples of a user interface screen for describing a process of managing a member of a shared account according to at least one example embodiment.

### DETAILED DESCRIPTION

One or more example embodiments will be described in detail with reference to the accompanying drawings. Example embodiments, however, may be embodied in various different forms, and should not be construed as being limited to only the illustrated embodiments. Rather, the illustrated embodiments are provided as examples so that this disclosure will be thorough and complete, and will fully convey the concepts of this disclosure to those skilled in the art. Accordingly, known processes, elements, and techniques, may not be described with respect to some example embodiments. Unless otherwise noted, like reference characters denote like elements throughout the attached drawings and written description, and thus descriptions will not be repeated.

As used herein, the singular forms “a,” “an,” and “the,” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups, thereof. As used herein, the term “and/or” includes any and all combinations of one or more of the associated listed products. Expressions such as “at least one of,” when preceding a list of elements, modify the entire list of elements and do not modify the individual elements of the list. Also, the term “exemplary” is intended to refer to an example or illustration.

Unless otherwise defined, all terms (including technical and scientific terms) used herein have the same meaning as commonly understood by one of ordinary skill in the art to which example embodiments belong. Terms, such as those defined in commonly used dictionaries, should be interpreted as having a meaning that is consistent with their meaning in the context of the relevant art and/or this disclosure, and should not be interpreted in an idealized or overly formal sense unless expressly so defined herein.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as one computer processing device; however, one skilled in the art will appreciate that a hardware device may include multiple processing elements and multiple types of processing elements. For example, a hardware device may include multiple processors or a processor and a controller. In addition, other processing configurations are possible, such as parallel processors.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

Hereinafter, example embodiments will be described with reference to the accompanying drawings.

The example embodiments relate to technology for processing authorization of a transaction in a shared account.

The example embodiments including the disclosures described herein may process a transaction in a shared account through prior authorization from users using a messenger, and accordingly may manage the shared account based on participation of the users and may prevent or mitigate the fraudulent use of the shared account.

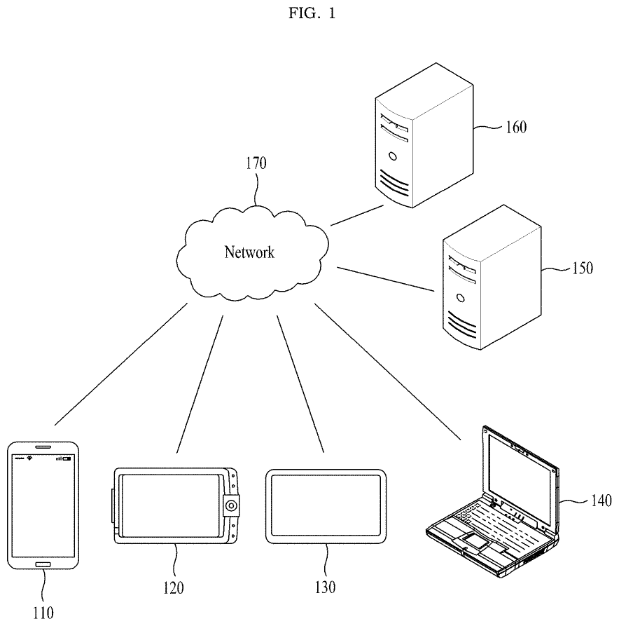

FIG. 1 illustrates an example of a network environment according to at least one example embodiment. Referring to FIG. 1, the network environment may include a plurality of electronic devices 110, 120, 130, and 140, a plurality of servers 150 and 160, and a network 170. FIG. 1 is provided as an example only. A number of electronic devices or a number of servers is not limited thereto.

Each of the plurality of electronic devices 110, 120, 130, and 140 may be a fixed terminal or a mobile terminal that is configured as a computer apparatus. For example, the plurality of electronic devices 110, 120, 130, and 140 may be a smartphone, a mobile phone, a navigation device, a computer, a laptop computer, a digital broadcasting terminal, a personal digital assistant (PDA), a portable multimedia player (PMP), a tablet PC, a game console, a wearable device, an Internet of things (IoT) device, a virtual reality (VR) device, an augmented reality (AR) device, and the like. For example, although FIG. 1 illustrates a shape of a smartphone as an example of the electronic device 110, the electronic device 110 used herein may refer to one of various types of physical computer apparatuses capable of communicating with other electronic devices 120, 130, and 140, and/or the servers 150 and 160 over the network 170 in a wireless or wired communication manner.

The communication scheme is not limited and may include a near field wireless communication scheme between devices as well as a communication scheme using a communication network (e.g., a mobile communication network, wired Internet, wireless Internet, a broadcasting network, a satellite network, etc.) includable in the network 170. For example, the network 170 may include at least one of network topologies that include a personal area network (PAN), a local area network (LAN), a campus area network (CAN), a metropolitan area network (MAN), a wide area network (WAN), a broadband network (BBN), and Internet. Also, the network 170 may include at least one of network topologies that include a bus network, a star network, a ring network, a mesh network, a star-bus network, a tree or hierarchical network, and the like. However, they are provided as examples only.

Each of the servers 150 and 160 may be configured as a computer apparatus or a plurality of computer apparatuses that provides an instruction, a code, a file, content, a service, etc., through communication with the plurality of electronic devices 110, 120, 130, and 140 over the network 170. For example, the server 150 may be a system that provides a first service to the plurality of electronic devices 110, 120, 130, and 140 connected over the network 170. The server 160 may be a system that provides a second service to the plurality of electronic devices 110, 120, 130, and 140 connected over the network 170. In detail, the server 150 may provide, as the first service, a service (e.g., an Internet banking service) intended by an application through the application as a computer program installed and executed on the plurality of electronic devices 110, 120, 130, and 140. As another example, the server 160 may provide, as the second service, a service that distributes a file for installing and executing the application to the plurality of electronic devices 110, 120, 130, and 140.

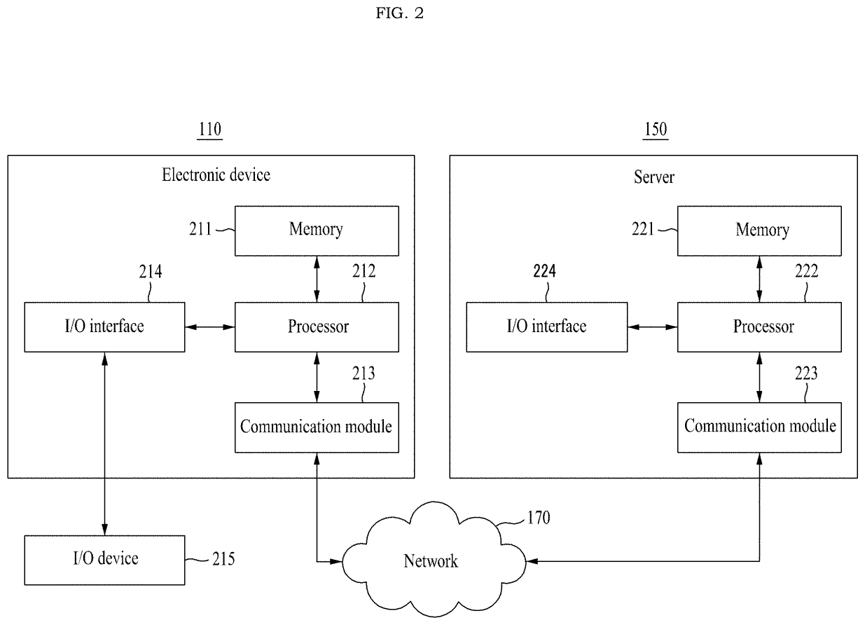

FIG. 2 is a block diagram illustrating an example of an electronic device and a server according to at least one example embodiment. Description is made using the electronic device 110 as an example of an electronic device and the server 150 as an example of a server with reference to FIG. 2. Also, the other electronic devices 120, 130, and 140 or the server 160 may have the same or similar configuration as that of the electronic device 110 or the server 150.

Referring to FIG. 2, the electronic device 110 may include a memory 211, a processor 212, a communication module 213, and an input/output (I/O) interface 214, and the server 150 may include a memory 221, a processor 222, a communication module 223, and an I/O interface 224. The memory 211, 221 may include a permanent mass storage device, such as random access memory (RAM), a read only memory (ROM), a disk drive, a solid state drive (SSD), a flash memory, etc., as a non-transitory computer-readable record medium. The permanent mass storage device, such as ROM, SSD, flash memory, and disk drive, may be included in the electronic device 110 or the server 150 as a permanent storage device separate from the memory 211, 221. Also, an OS and at least one program code, for example, a code for a browser installed and executed on the electronic device 110 or an application installed and executed on the electronic device 110 to provide a specific service, may be stored in the memory 211, 221. Such software components may be loaded from another non-transitory computer-readable record medium separate from the memory 211, 221. The other non-transitory computer-readable record medium may include a non-transitory computer-readable record medium, for example, a floppy drive, a disk, a tape, a DVD/CD-ROM drive, a memory card, etc. According to other example embodiments, software components may be loaded to the memory 211, 221 through the communication module 213, 223, instead of the non-transitory computer-readable record medium. For example, at least one program may be loaded to the memory 211, 221 based on a computer program, for example, the application, installed by files provided over the network 170 from developers or a file distribution system, for example, the server 160, providing an installation file of the application.

The processor 212, 222 may be configured to process instructions of a computer program by performing basic arithmetic operations, logic operations, and I/O operations. The computer-readable instructions may be provided from the memory 211, 221 or the communication module 213, 223 to the processor 212, 222. For example, the processor 212, 222 may be configured to execute received instructions in response to the program code stored in the storage device, such as the memory 211, 221.

The communication module 213, 223 may provide a function for communication between the electronic device 110 and the server 150 over the network 170 and may provide a function for communication between the electronic device 110 and/or the server 150 and another electronic device, for example, the electronic device 120 or another server, for example, the server 160. For example, the processor 212 of the electronic device 110 may transfer a request created based on a program code stored in the storage device such as the memory 211, to the server 150 over the network 170 under control of the communication module 213. Inversely, a control signal, an instruction, content, a file, etc., provided under control of the processor 222 of the server 150 may be received at the electronic device 110 through the communication module 213 of the electronic device 110 by going through the communication module 223 and the network 170. For example, a control signal, an instruction, content, a file, etc., of the server 150 received through the communication module 213 may be transferred to the processor 212 or the memory 211, and content, a file, etc., may be stored in a storage medium, for example, the permanent storage device, further includable in the electronic device 110.

The I/O interface 214 may be a device used for interface with an I/O apparatus 215. For example, an input device may include a device, such as a keyboard, a mouse, a microphone, a camera, etc., and an output device may include a device, such as a display, a speaker, a haptic feedback device, etc. As another example, the I/O interface 214 may be a device for interface with an apparatus in which an input function and an output function are integrated into a single function, such as a touchscreen. The I/O apparatus 215 may be configured as a single device with the electronic device 110. Also, the I/O interface 224 of the server 150 may be a device for interface with an apparatus (not shown) for input or output that may be connected to the server 150 or included in the server 150. In detail, when the processor 212 of the electronic device 110 processes an instruction of a computer program loaded to the memory 211, content or a service screen configured based on data provided from the server 150 or the electronic device 120 may be displayed on the display through the I/O interface 214.

According to other example embodiments, the electronic device 110 and the server 150 may include a number of components greater than or less than a number of components shown in FIG. 2. However, there is no need to clearly illustrate many components according to the related art. For example, the electronic device 110 may include at least a portion of the I/O apparatus 215, or may further include other components, for example, a transceiver, a global positioning system (GPS) module, a camera, a variety of sensors, a database (DB), and the like. In detail, if the electronic device 110 is a smartphone, the electronic device 110 may be configured to further include a variety of components, for example, an acceleration sensor, a gyro sensor, a camera module, various physical buttons, a button using a touch panel, an I/O port, a vibrator for vibration, etc., which are generally included in the smartphone.

Hereinafter, a method and system for prior authorization of a transaction in a shared account according to example embodiments is described.

The term “shared account” used herein refers to a bank deposit account in which a deposit and a withdrawal may be made, that is, an account in which a plurality of users may deposit an amount and share the usage details (deposit and withdrawal details) of the corresponding account. Users capable of participating in the shared account may include a user (hereinafter, referred to as a master) corresponding to an account holder having opened a corresponding account and a user (hereinafter, referred to as a member) registered by the master as an account sharing target. Here, the master may have the transaction authority to use a deposit amount in the shared account for a payment, a withdrawal, and a remittance, and the member may have the participation authority to share the usage details of the deposit amount in the shared account. For example, the member may have the authorization authority for a transaction in the shared account to mitigate or prevent the master from fraudulently using the shared account. Depending on some example embodiments, at least a portion of members may have the temporary transaction authority on behalf of the master according to settings of the master.

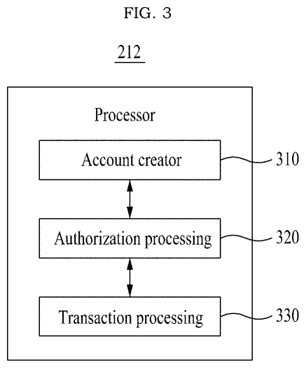

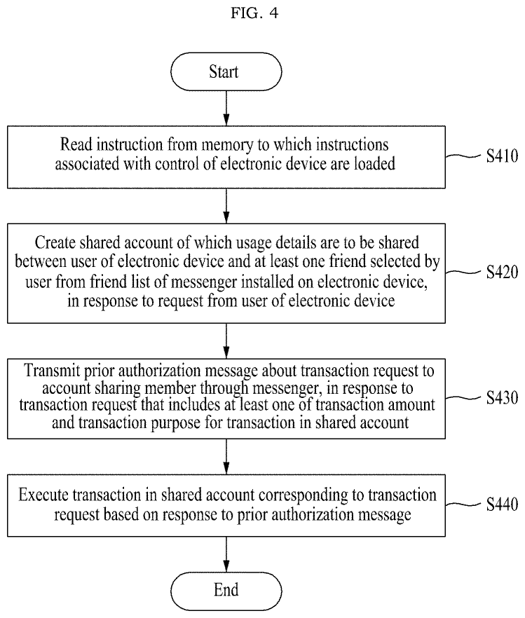

FIG. 3 is a diagram illustrating an example of components includable in a processor of an electronic device according to at least one example embodiment, and FIG. 4 is a flowchart illustrating an example of a method performed by an electronic device according to at least one example embodiment.

A shared account transaction system implemented as a computer may be configured in the electronic device 110 according to the example embodiment. For example, the shared account transaction system may be configured in a form of an independently operating program or may be configured in an in-app form of a specific application to be operable on the specific application. Depending on some example embodiments, the shared account transaction system may provide an Internet banking service (e.g., online banking service) through interaction with the server 150.

The shared account transaction system implemented in the electronic device 110 may perform the shared account transaction method of FIG. 4 in response to an instruction provided from the application installed on the electronic device 110.

Referring to FIG. 3, to perform the shared account transaction method of FIG. 4, the processor 212 of the electronic device 110 may include an account creator 310, an authorization processing 320, and a transaction processing 330 as components. Depending on some example embodiments, the components of the processor 212 may be selectively included in or excluded from the processor 212. Also, depending on some example embodiments, the components of the processor 212 may be separated or merged for representations of functions of the processor 212.

The processor 212 and the components of the processor 212 may control the electronic device 110 to perform operations S410 to S440 included in the shared account transaction method of FIG. 4. For example, the processor 212 and the components of the processor 212 may be configured to execute an instruction according to a code of at least one program and a code of an OS included in the memory 211.

Here, the components of the processor 212 may be representations of different functions of the processor 212 performed by the processor 212 in response to an instruction provided from the program code stored in the electronic device 110, for example, an instruction provided from the application executed on the electronic device 110. For example, the account creator 310 may be used as a functional representation of the processor 212 that controls the electronic device 110 to create a shared account in response to the instruction.

Referring to FIG. 4, in operation S410, the processor 212 may read an instruction from the memory 211 to which instructions associated with control of the electronic device 110 are loaded. In this case, the read instruction may include an instruction for controlling the processor 212 to perform the following operations S420 to S440.

In operation S420, in response to a request from a user of the electronic device 110, the account creator 310 may create a shared account of which usage details are to be shared between the user of the electronic device 110 and at least one friend selected by the user from a friend list of a messenger installed on the electronic device 110 and interactable with the shared account transaction system implemented on the electronic device 110, through interaction with the server 150. That is, as an account associated with the user of the electronic device 110 (e.g., a deposit account of which an account holder is the user of the electronic device 110), the account creator 310 may create the shared account in which the user of the electronic device 110 is a master having the transaction authority and a messenger friend selected by the user of the electronic device 110 is a member having the participation authority and the authorization authority. Here, creating the shared account may include creating a new shared account by switching an existing account associated with the user of the electronic device 110 (e.g., a deposit account of which an account holder is the user of the electronic device 110) to the shared account. The account creator 310 may transmit an invitation message to participate as a member in the shared account to the friend selected by the user of the electronic device 110 through the messenger, and may register and manage a friend that accepts participation in the shared account (or a friend that transmits a response accepting the invitation message), as a member of the shared account.

During a process of creating the shared account, the account creator 310 may set a prior authorization rule related to the shared account by the user of the electronic device 110. The prior authorization rule may include a transaction condition and a valid authorization processing condition that require prior authorization. Here, the transaction condition may include a business type category, a transaction amount, and a transaction time that require the prior authorization, and the valid authorization processing condition for the prior authorization may include a number of members, a rate (e.g., percentage) of members, and a response time that are recognized as valid authorization for the prior authorization. Here, the valid authorization processing condition may be determined for each transaction condition. For example, in regard with the transaction condition, a rule may be set to omit the prior authorization for payments in a category of food materials or restaurants and to seek the prior authorization for payments in the rest of business. In some example embodiments, a rule may be set to omit the prior authorization for payments less than or equal to a desired amount, and to require the prior authorization for payments greater than the desired amount. In some other example embodiments, a rule may be set to omit the prior authorization for payments in the daytime (e.g., 08:00 to 18:59) and to seek the prior authorization for payments in the nighttime (e.g., 19:00 to 07:59). Also, in regard with the valid authorization processing condition, for example, if a predetermined (or, alternatively, desired) number of members (e.g., one member) or a predetermined (or, alternatively, desired) rate (e.g., percentage) of members (e.g., 10%) accept a corresponding transaction within a preset (or alternatively, desired) period of time (e.g., 1 hour), it may be processed as valid authorization. Here, a member who does not express an intent to “deny” during the period of time may be processed as a member having an intent to “accept.” As another example, a rule may be set to process a payment less than or equal to a desired amount as the valid authorization if a predetermined (or, alternatively, desired) number of members (e.g., one member) or a predetermined (or, alternatively, desired) rate of members (e.g., 10%) accept a corresponding transaction, and to process a payment greater than the desired amount as the valid authorization if all of the members accept the corresponding transaction. The prior authorization rule may be set for each type of transaction, for example, a payment, a remittance, and a withdrawal.

In addition to the aforementioned examples, the prior authorization rule related to the shared account may be set through combination of various conditions.

In operation S430, in response to a transaction request that includes at least one of a transaction amount and a transaction purpose for a transaction in the shared account, the authorization processing 320 may transmit a prior authorization message about the transaction request to a member of the shared account through a messenger installed on the electronic device 110. The prior authorization message refers to a message about confirmation to acquire prior acceptance from members (e.g., a message indicating prior acceptance from members) before the master uses a deposit amount of the shared account for a payment, a withdrawal, or a remittance, and may include an action message that includes a user interface (UI) for selectively inputting an intent to accept or deny the transaction request, which includes, for example, the deposit amount and/or the transaction type of the shared account.

For example, a transaction amount and a transaction purpose may be directly selected or input from the user of the electronic device 110 for a transaction using the shared account. Here, the authorization processing 320 may transmit a prior authorization message in response to a transaction request that includes at least one of the transaction amount and the transaction purpose selected by the user of the electronic device 110. As another example, in response to a transaction request using the shared account as a payment method from a shopping platform interactable with the shared account transaction system implemented on the electronic device 110, the authorization processing 320 may acquire shopping information (e.g., a payment amount, a business type, and/or a product category) of the user of the electronic device 110 from the corresponding shopping platform, and may transmit the prior authorization message that includes the acquired shopping information to the member of the shared account. Here, the payment amount included in the shopping information may correspond to the transaction amount and the business type or the product category included in the shopping information may correspond to the transaction purpose. If payment request information (e.g., a payment amount and/or a business type or a product category) of an affiliate store is acquirable at a time of a payment request using the shared account at the affiliate store online/offline, the authorization processing 320 may transmit the prior authorization message that includes the corresponding payment request information to the member of the shared account.

If the transaction request from the user of the electronic device 110 corresponds to the transaction condition that requires the prior authorization based on the prior authorization rule related to the shared account, the authorization processing 320 may transmit the prior authorization message to the member of the shared account. The authorization processing 320 may receive a response message, for example, indicating an intent to accept or deny the prior authorization message from the member of the shared account, and may forward the received response message to the user of the electronic device 110 through the messenger.

In operation S440, the transaction processing 330 may execute the transaction in the shared account corresponding to the transaction request based on a response to the prior authorization message. Here, if a response received from members with respect to the prior authorization message (e.g., a response indicating an intent to accept or deny the prior authorization message) meets the valid authorization processing condition based on the prior authorization rule related to the shared account, the transaction processing 330 may allow the corresponding transaction in the shared account. Although the response from the members with respect to the prior authorization message (e.g., a response indicating an intent to accept or deny the prior authorization message) meets the valid authorization processing condition, at least one member may transmit a response indicating an intent to deny the prior authorization message. In this case, the transaction processing 330 may hold the transaction in the shared account corresponding to the transaction request without executing the transaction.

If an actual transaction contents of the shared account correspond to transaction contents for which prior authorization has been acquired from members, the transaction processing 330 may execute the transaction in the shared account. For example, if an actual transaction amount matches a transaction amount included in a transaction request (e.g., the actual transaction amount being equal to or less than the prior authorization amount), the transaction processing 330 may execute a transaction in the shared account. As another example, the transaction processing 330 may execute a transaction in the shared account only with respect to an affiliate store of a business type category corresponding to a transaction purpose included in the transaction request (e.g., a prior authorization purpose). Accordingly, although the user of the electronic device 110 is a master having the transaction authority for the shared account, the transaction in the shared account may be made after confirmation is made based on the prior authorization acquired from the members for an amount to be used or for a transaction purpose.

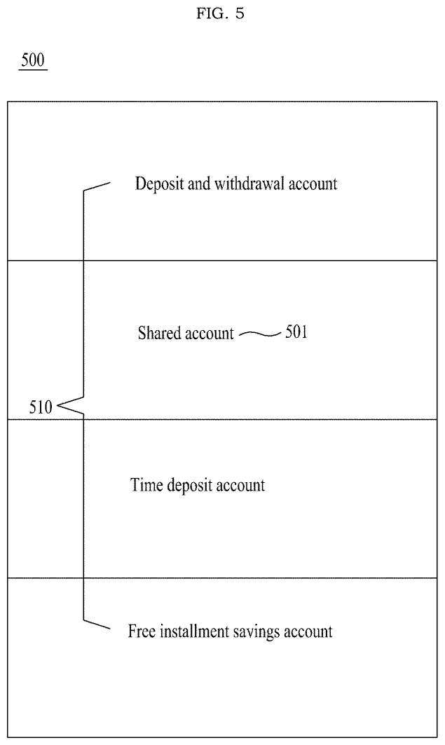

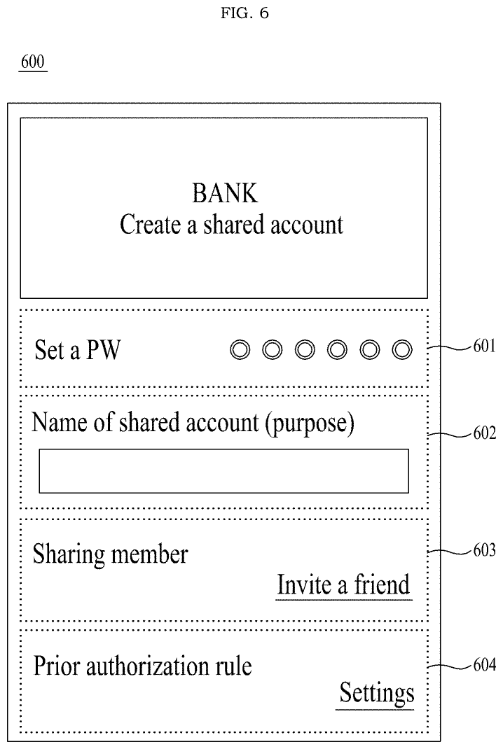

FIGS. 5 and 6 illustrate examples of a user interface screen for describing a process of creating a shared account according to at least one example embodiment.

FIG. 5 illustrates an account creation screen 500 displayed on a screen of the electronic device 110.

Referring to FIG. 5, in response to a request from the user of the electronic device 110, the processor 212 may provide the account creation screen 500 including a creatable account type list 510. Here, the account type list 510 may include bank deposit accounts providable at an Internet banking service, such as, for example, a deposit and withdrawal account, a shared account 501, a time deposit account, and a free installment savings account.

In response to a selection from the user on a ‘Shared account’ menu 501 on the account type list 510, the processor 212 may provide a shared account creation screen 600 for creating a shared account as illustrated in FIG. 6.

The shared account creation screen 600 refers to an interface screen for inputting information required to create a shared account and may include a ‘Set a PW’ menu 601 for setting a password (PW) of the shared account, a ‘Name of shared account’ menu 602 for setting a name (e.g., a nickname related to purpose) of the shared account, a ‘Sharing member’ menu 603 for setting a member of the shared account, and a ‘Prior authorization rule’ menu 604 for setting a prior authorization rule about the shared account.

A member of the shared account may be set using a friend list on a messenger installed on the electronic device 110 through interaction with the messenger. In response to a selection from the user on the ‘Sharing member’ menu 603, the processor 212 may call the friend list added to the messenger through interaction with the messenger, and may provide an interface capable of adding at least one friend selected by the user from the friend list as a member to participate in the shared account. The ‘Prior authorization rule’ menu 604 may support direction to an interface screen for setting the prior authorization rule of the shared account. The prior authorization rule may include a transaction condition (e.g., a business type category, a transaction amount, and a transaction time) and a valid authorization processing condition (e.g., a number of members, a rate of members, and a time recognized as valid authorization) that need the prior authorization. Here, the valid authorization processing condition may be differently set based on transaction condition.

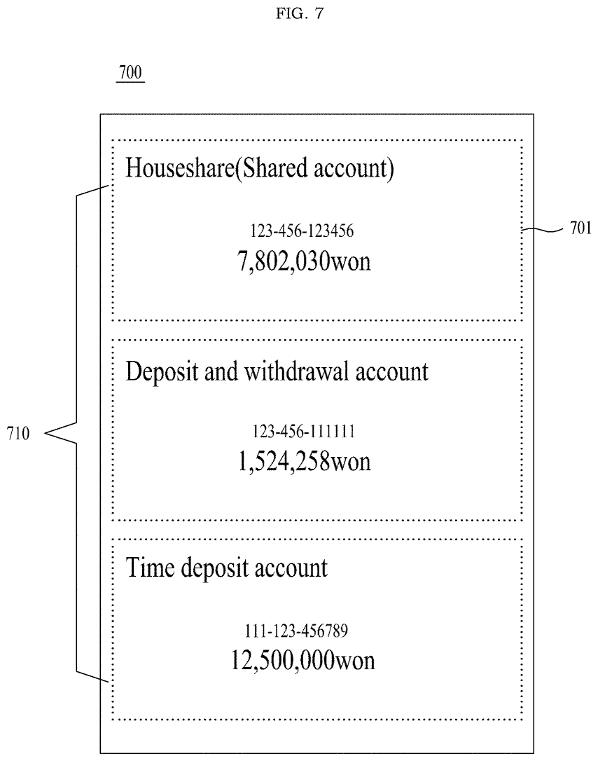

FIGS. 7 to 10 illustrate examples of a user interface screen for describing a process of processing prior authorization of a transaction in a shared account according to at least one example embodiment.

FIG. 7 illustrates a holding account screen 700 displayed on the screen of the electronic device 110. Referring to FIG. 7, the holding account screen 700 may include a holding account list 710 in which the user of the electronic device 110 is an account holder and the holding account list 710 may include a shared account 701 of which usage details are to be shared with messenger friends of the user.

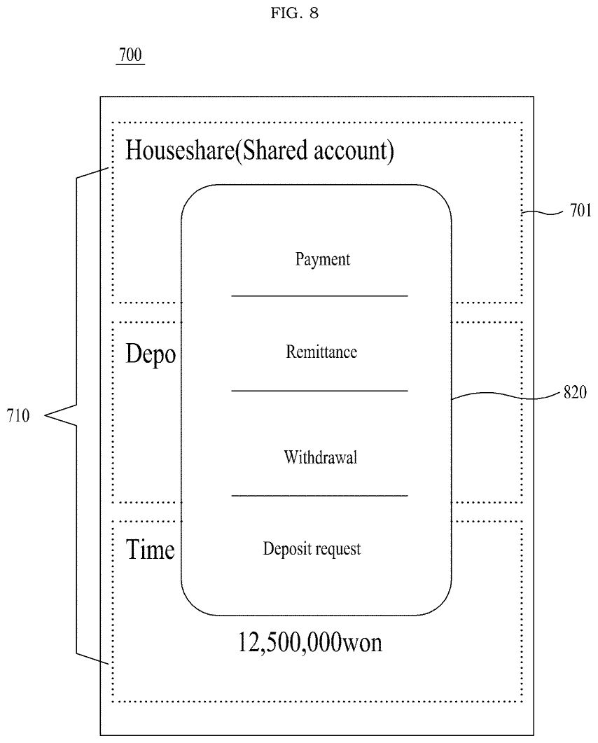

Referring to FIG. 8, in response to a selection from the user on the shared account 701 of the holding account list 710, the processor 212 may provide a transaction type list 820. The transaction type list 820 may include transactions (e.g., a payment, a remittance, a withdrawal, and a deposit request) executable using the shared account 701.

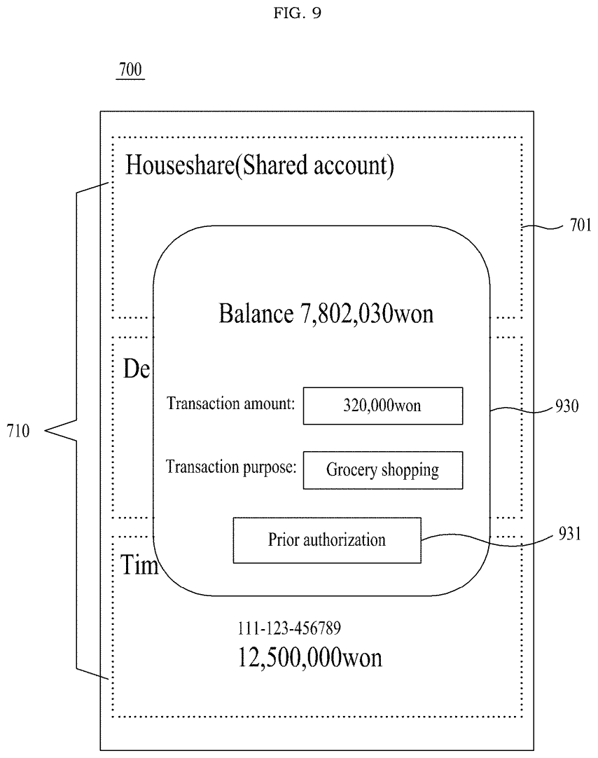

Referring to FIG. 9, in response to a selection from the user on a single transaction type from the transaction type list 820, the processor 212 may provide a transaction content input screen 930 for inputting the transaction contents of at least one of a transaction amount and a transaction purpose.

The transaction content input screen 930 may include an interface that allows the user to directly select or input the transaction amount and the transaction purpose. As another example, in response to a payment request using the shared account 701 at an online/offline affiliate store, the transaction amount and the transaction purpose may be extracted from payment request information (e.g., a payment amount, a business type and/or a product category of the affiliate store and thereby automatically input.

The transaction content input screen 930 may include a ‘Prior authorization’ menu 931 for requesting a member of the shared account 701 for prior authorization with respect to the transaction contents including at least one of the transaction amount and the transaction purpose.

In response to a selection from the user on the ‘Prior authorization’ menu 931 in a state in which at least one of the transaction amount and the transaction purpose is input on the transaction content input screen 930, the processor 212 may transmit a prior authorization message that includes the corresponding transaction contents to the member of the shared account 701 through a messenger installed on the electronic device 110.

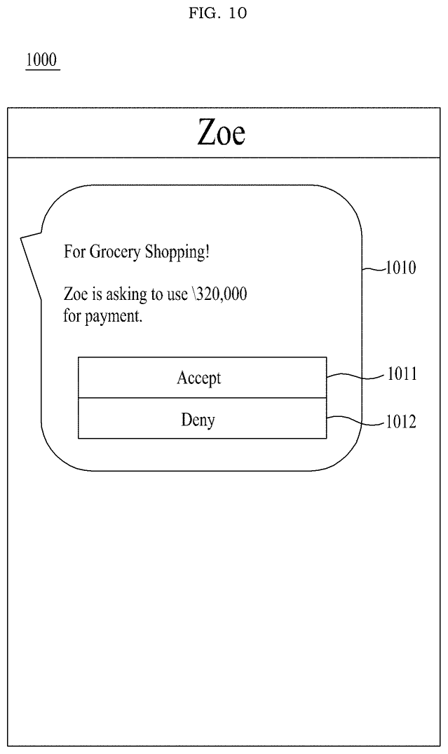

FIG. 10 illustrates an example of a messenger screen 1000 displayed on a screen on an electronic device, for example, the electronic device 120, of a member that receives a prior authorization message according to at least one example embodiment.

Referring to FIG. 10, a member of a shared account may verify a prior authorization message 1010 received from a master (e.g., the user of the electronic device 110), through the messenger screen 1000. The prior authorization message 1010 may include the transaction contents (at least one of a transaction amount and a transaction purpose) of the shared account the master desires to use, and may include an “Accept” menu 1011 for inputting the intent to accept and a “Deny” menu 1012 for inputting the intent to deny with respect to the transaction contents. A response to the prior authorization message 1010 may be input from a member that receives the prior authorization message 1010 using the “Accept” menu 1011 and the “Deny” menu 1012 on the messenger screen 1000. Here, the processor 212 may receive the response (intent to accept or deny) to the prior authorization message 1010 input from the member of the shared account through a messenger, and may create a response message based on the received response such that the corresponding response may be forwarded to the user of the electronic device 110 through the messenger. According to another example embodiment, the processor 212 may receive the response (intent to accept or deny) to the prior authorization message 1010 input from the member of the shared account through the messenger, and may transmit the received response to the server 150. According to another example embodiment, the processor 212 may receive the response (intent to accept or deny) to the prior authorization message 1010 input from the member of the shared account through the messenger, and may transmit the received response to the server 160 such that the received response may be forwarded to the user of the electronic device 110. For example, if a desired number of members (e.g., one member) or a desired rate (e.g., percentage) of members (e.g., 10%) accept the transaction contents of the shared account the master desires to use, the processor 212 may authorize the transaction in the shared account. According to an example embodiment, the processor 212 may determine whether a desired number of members (e.g., one member) or a desired rate of members (e.g., 10%) accept the transaction contents of the shared account the master desires to use based on the response message created based on the response(s) received from the member(s) of the shared account and may authorize the transaction in the shared account based on the determination result. Here, if at least one member forwards the intent to deny, the processor 212 may hold the transaction authorization for the shared account regardless of acceptance from the desired number of members (e.g., one member) or the desired rate of members (e.g., 10%). Also, a member that does not transmit the response (e.g., intent to accept or deny) during a preset period of time or more (e.g., 1 hour) may be regarded as a member that responds with the intent to accept. According to another example embodiment, the processor 212 may receive, from the server 150 or the server 160, information regarding whether the desired number of members (e.g., one member) or the desired rate of members (e.g., 10%) accept the transaction contents of the shared account the master desires to use, and may authorize the transaction in the shared account based on the received information.

If prior authorization has been acquired from members with respect to the transaction contents of the shared account, the processor 212 may execute the transaction in the shared account in limitation to the prior authorized transaction contents. For example, referring to FIG. 9, in an example in which prior authorization has been received from members with respect to grocery shopping for which the master spending 320,000 won, the processor 212 may execute a corresponding transaction in the shared account only when an actual transaction in the shared account corresponds to a prior authorization purpose “grocery shopping” and corresponds to a prior authorization amount “320,000 won” or less.

The master may select, from the transaction type list 820 of FIG. 8, a “Deposit request” menu for requesting members to make a deposit to the shared account, may input at least one of a deposit amount and a deposit purpose, and may forward a deposit request for the corresponding contents to the members. Here, a deposit request message may be created on the messenger by the processor 212 based on at least one of the deposit amount and the deposit purpose input from the master and may be transmitted to the members through the messenger. As another example, at least one of the deposit amount and the deposit purpose input from the master may be transmitted to the server 150 or the server 160 and the deposit request message created based on the input at least one of the deposit amount and the deposit purpose may be transmitted from the server 150 or the server 160 to the members through the messenger. If a deposit is made to the shared account by the members in response to the deposit request from the master, the processor 212 may regard this as the prior authorization. Accordingly, in the case of a transaction with the same contents as the deposit requested contents (deposit amount and deposit purpose) that follows the deposit request from the master and the deposit of the members, the transaction in the shared account may be executed without the prior authorization from the members. That is, in the case of a transaction associated with the deposit request for the shared account, the processor 212 may omit a prior authorization procedure. In other words, if a deposit has been made from or by non-master members of the shared account in response to a deposit request to the shared account from the master of the shared account, and then a transaction request for the shared account occurs with respect to a transaction linked to the deposit request, the transaction linked to the deposit request may be executed without prior authorization.

The processor 212 may monitor transactions in the shared account, and may provide a notification about a transaction corresponding to a fraudulent use condition to members of the shared account. For example, the processor 212 may determine a transaction for which prior authorization is not acquired among transactions in the shared account as a target to be monitored. For example, if transactions, such as a payment, a remittance, and a withdrawal, using the shared account occur within a preset (or certain) period of time, for example, within 10 minutes, or if the transactions occur between locations within a predetermined (or, alternatively, desired) radius, for example, 100 km, the processor 212 may determine a corresponding transaction as the fraudulent use and may provide a notification about the fraudulent use to members of the shared account.

Basically, the prior authorization procedure may be performed in response to a transaction request, such as a payment, a remittance, and a withdrawal using the shared account. Depending on some example embodiments, in response to a change in settings related to the shared account by the master, members may be requested for the prior authorization.

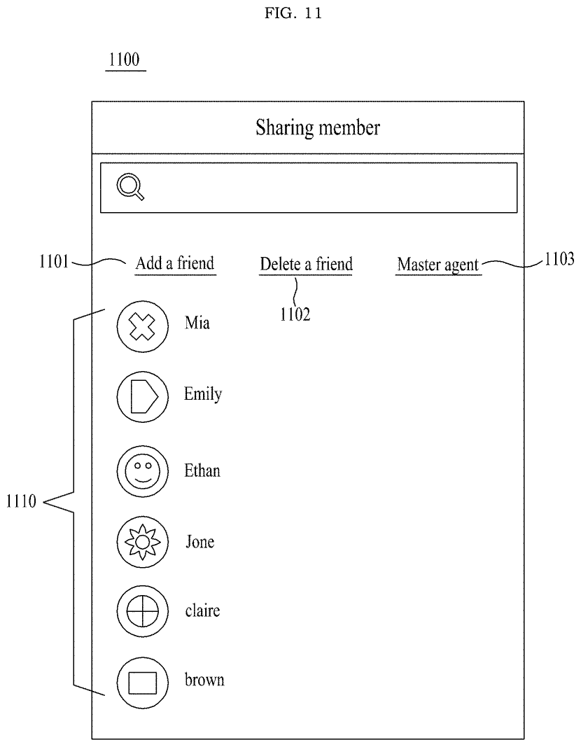

For example, in response to a deletion request or an addition request for a member of the shared account, the processor 212 may transmit a prior authorization message about a member deletion or a member addition to other members. Referring to FIG. 11, in response to a request from the user of the electronic device 110, the processor 212 may provide a sharing member screen 1100 for managing members of the shared account.

The sharing member screen 1100 may include a list 1110 of members of the shared account registered by the user of the electronic device 110, that is, a master, and may also include an “Add a friend” menu 1101 for adding a member of the shared account, a “Delete a friend” menu 1102 for deleting a member of the shared account, and a “Master agent” menu 1103 for assigning the master authority to a member of the shared account.

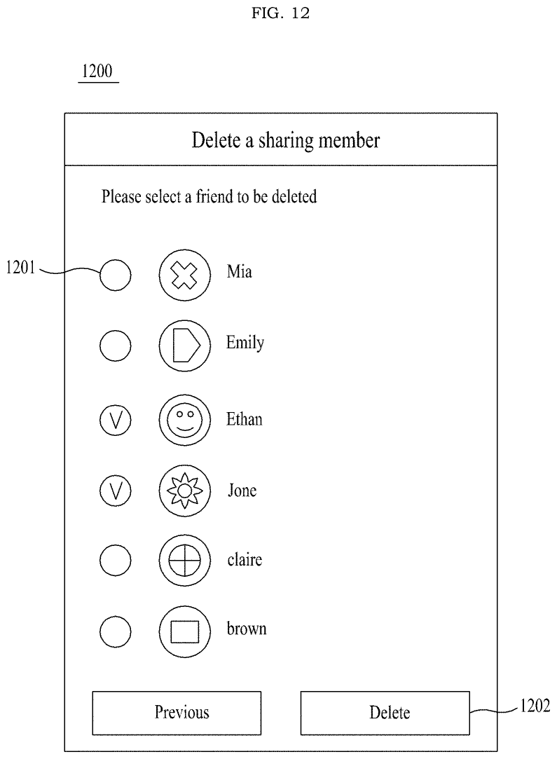

For example, in response to a selection from the user on the “Delete a friend” menu 1102, the processor 212 may provide a sharing member deletion screen 1200 of FIG. 12. Here, if the user selects a member to delete from among members of the shared account through a check box 1201 and then selects a “Delete” menu 1202, the processor 212 may provide a prior authorization message that includes information (e.g., a name of the member) about the selected member to members of the shared account for a prior authorization procedure for member deletion. For example, the prior authorization procedure may be performed in response to a deletion request corresponding to a preset (or alternatively, desired) condition, which includes, for example, a case in which the user desires to collectively or consecutively delete a predetermined (or, alternatively, desired) number of members or at least a predetermined (or, alternatively, desired) rate of members, or a case in which a member deletion event occurs with a preset (or alternatively, desired) frequency within a preset (or alternatively, desired) period of time. The prior authorization message may be transmitted to remaining members excluding the member to be deleted. If a predetermined (or, alternatively, desired) number of members (e.g., one member) or a predetermined (or, alternatively, desired) of members (e.g., 10%) accept the member deletion, the processor 212 may delete the corresponding member from the members of the shared account. Here, whether the predetermined (or, alternatively, desired) number of members (e.g., one member) or the predetermined (or, alternatively, desired) number of members (e.g., 10%) accept the member deletion may be determined by the processor 212 or may be determined based on information forwarded from the server 150 or the server 160.

Likewise, a process of adding a member of the shared account may perform a prior authorization procedure for the member addition depending on cases.

Although the example embodiment describes that the master adds or deletes a member of the shared account, it is provided as an example only. A member may add or delete a member of the shared account through the prior authorization from other members including the master.

As another example, the processor 212 may set a single member among members of the shared account to temporarily have the master authority in response to a request from the user of the electronic device 110, that is, the master. Here, the processor 212 may transmit a prior authorization message about a master agent (e.g., temporary master agent) setting to other members. The processor 212 may limit the transaction authority for the shared account by setting at least one of a transaction type, a business type category, a time, and an amount for which the master authority is valid during a processing of setting the master agent. Also, the processor 212 may set the master agent for each business type category, for each transaction amount, or for each transaction time through a user setting.

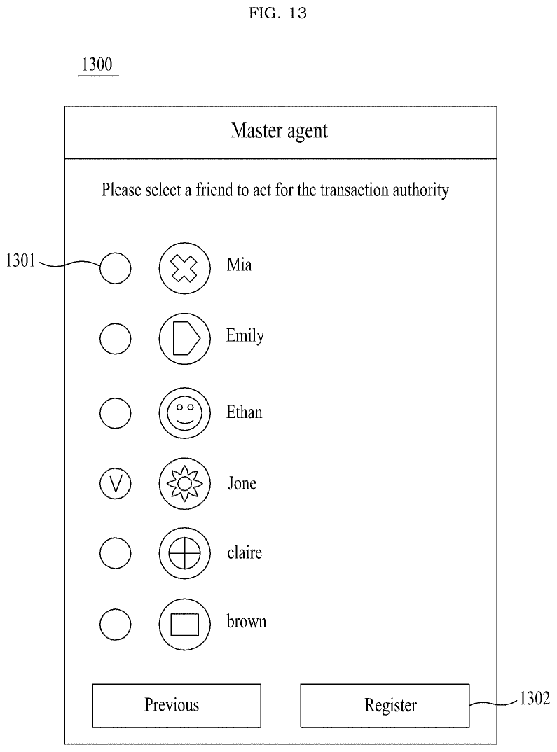

For example, in response to a selection from the user on the “Master agent” menu 1103 on the sharing member screen 1100 of FIG. 11, the processor 212 may provide a master agent setting screen 1300 of FIG. 13. Here, if the user selects a member to be granted with the master authority from among members of the shared account through a check box 1301 and then selects a “Register” menu 1302, a prior authorization message that includes information (e.g., a name of the member) about the selected member may be transmitted to members of the shared account through the messenger as a prior authorization procedure for the master agent setting. The prior authorization message may be transmitted to remaining members excluding the selected member. If a predetermined (or, alternatively, desired) number of members (e.g., one member) or a predetermined (or, alternatively, desired) rate of members (e.g., 10%) accept the master agent setting, the processor 212 may grant the corresponding member with the master authority, that is, the transaction authority. Here, whether the predetermined (or, alternatively, desired) number of members (e.g., one member) or the predetermined (or, alternatively, desired) rate of members (e.g., 10%) accept the master agent setting may be determined by the processor 212 or may be determined based on information forwarded from the server 150 or the server 160.

Therefore, the example embodiments may enable seeking prior authorization from members for a transaction, such as a payment, a remittance, and a withdrawal, of the shared account, and modifying at least a portion of settings related to the shared account, such as deleting/adding a member of the shared account or granting the transaction authority to a member of the shared account.

Interface screens of FIGS. 5 to 13 are provided as examples only and a screen configuration associated with the shared account or an access path and a screen switching order may be readily changed.

According to some example embodiments, it is possible to execute a corresponding transaction through the prior authorization from members using a messenger for a transaction in a shared account. Therefore, it is possible to mitigate or prevent the fraudulent use of the shared account by effectively monitoring the authority of a master for the shared account. Thus, some example embodiments implement methods of and/or systems for mitigating or preventing the fraudulent use of the shared account that use relatively less computing/communication resources, and thus consume less power.

The systems or apparatuses described above may be implemented using hardware components, software components, and/or a combination thereof. For example, the apparatuses and the components described herein may be implemented using one or more general-purpose or special purpose computers, such as, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For simplicity, the description of a processing device is used as singular; however, one skilled in the art will be appreciated that a processing device may include multiple processing elements and/or multiple types of processing elements. For example, a processing device may include multiple processors or a processor and a controller. In addition, different processing configurations are possible, such as parallel processors.

The software may include a computer program, a piece of code, an instruction, or some combination thereof, for independently or collectively instructing or configuring the processing device to operate as desired. Software and/or data may be embodied permanently or temporarily in any type of machine, component, physical equipment, virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more computer readable storage mediums.

The methods according to the above-described example embodiments may be configured in a form of program instructions performed through various computer devices and recorded in non-transitory computer-readable media. The media may also include, alone or in combination with the program instructions, data files, data structures, and the like. The media may continuously store computer-executable programs or may temporarily store the same for execution or download. Also, the media may be various types of recording devices or storage devices in a form in which one or a plurality of hardware components are combined. Without being limited to media directly connected to a computer system, the media may be distributed over the network. Examples of the media include magnetic media such as hard disks, floppy disks, and magnetic tapes; optical media such as CD-ROM and DVDs; magneto-optical media such as floptical disks; and hardware devices that are specially configured to store and perform program instructions, such as ROM, RAM, flash memory, and the like. Examples of other media may include recording media and storage media managed by Appstore that distributes applications or a site, a server, and the like that supplies and distributes other various types of software.

While this disclosure includes specific example embodiments, it will be apparent to one of ordinary skill in the art that various alterations and modifications in form and details may be made in these example embodiments without departing from the spirit and scope of the claims and their equivalents. For example, suitable results may be achieved if the described techniques are performed in a different order, and/or if components in a described system, architecture, device, or circuit are combined in a different manner, and/or replaced or supplemented by other components or their equivalents.

What is claimed is:

1. A shared account transaction method executed on a computer apparatus comprising at least one processor configured to execute computer-readable instructions included in a memory, the method comprising:
by the at least one processor,
in response to a shared account creation request from a user of the computer apparatus, creating a shared account of which usage details are to be shared between the user and at least one member selected by the user from a friend list of a messenger installed on the computer apparatus;
in response to a transaction request for the shared account, transmitting a prior authorization message about the transaction request to the at least one member through the messenger; and
executing a prior authorized transaction in the shared account based on a response of the at least one member to the prior authorization message.

2. The method of claim 1, wherein the transmitting comprises transmitting the prior authorization message that includes at least one of a transaction purpose and a transaction amount selected or input for a transaction in the shared account.

3. The method of claim 1, wherein the transmitting comprises transmitting the prior authorization message that includes payment request information of an affiliate store in response to a payment request using the shared account.

4. The method of claim 1, wherein the prior authorization message is configured as an action message that includes a user interface (UI) for inputting an intent to accept or deny to the transaction request.

5. The method of claim 1, wherein the transmitting comprises transmitting the prior authorization message if the transaction request corresponds to a transaction condition set to the shared account.

6. The method of claim 5, wherein the transaction condition includes, at least one of a business type category, an amount, and a time associated with the transaction.

7. The method of claim 5, wherein the executing comprises allowing the prior authorized transaction if a response to the prior authorization message meets a valid authorization processing condition set to the shared account.

8. The method of claim 7, wherein the valid authorization processing condition includes at least one of a number of members or a rate of members and a response time that are recognized as valid authorization.

9. The method of claim 7, wherein the valid authorization processing condition is differently set based on the transaction condition.

10. The method of claim 1, wherein the executing comprises allowing a transaction in the shared account if actual contents of the transaction of the shared account correspond to transaction contents for which prior authorization has been acquired from the at least one member.

11. The method of claim 1, further comprising:
by the at least one processor,
monitoring transactions in the shared account and providing members of the shared account with a notification about a certain transaction corresponding to a fraudulent use condition.

12. The method of claim 1, further comprising:
by the at least one processor,
monitoring transactions for which prior authorization is not acquired among the transactions in the shared account, and
determining whether a fraudulent use is present in the shared account based on at least one of a transaction time and a transaction location.

13. The method of claim 1, further comprising:
by the at least one processor,
in response to a change in a setting related to the shared account by the user, transmitting another prior authorization message about a setting change to the at least one member.

14. The method of claim 1, further comprising:
by the at least one processor,
in response to a deletion request to delete a select member from members of the shared account or an addition request to add the select member to the members of the shared account from the user, transmitting a prior authorization message that includes information about the select member to the members of the shared account other than the user.

15. The method of claim 1, further comprising:
by the at least one processor,
setting a certain member selected by the user from among members of the shared account as a temporary master agent having a transaction authority for the shared account.

16. The method of claim 15, wherein the setting comprises setting at least one of a transaction type, a business type category, a time, and an amount for which the transaction authority of the temporary master agent is valid.

17. The method of claim 15, further comprising:
by the at least one processor,
transmitting a prior authorization message about settings of the temporary master agent to the members of the shared account other than the user.

18. The method of claim 1, further comprising:
by the at least one processor,
executing a transaction linked to a deposit request without prior authorization, if a deposit is made from the at least one member in response to the deposit request to the shared account from the user and then the transaction request for the shared account occurs with respect to the transaction linked to the deposit request.

19. A non-transitory computer-readable record medium storing instructions that, when executed by the at least one processor, cause the at least one processor to perform the shared account transaction method of claim 1.

20. A server comprising:
at least one processor configured to execute computer-readable instructions included in a memory,
wherein the at least one processor is configured to
in response to a shared account creation request from a user of an electronic device, create a shared account of which usage details are to be shared between the user and at least one member,
in response to a transaction request for the shared account, transmit a prior authorization message about the transaction request for the shared account to at least one electronic device of the at least one member through a messenger installed on the electronic device of the user, and
execute a prior authorized transaction in the shared account based on a response of the at least one member to the prior authorization message.
